(19) United States
(12) Patent Application Publication
(10) Pub. No.: US 2008/0160231 A1
(43) Pub. Date: Jul. 3, 2008

(54) Ink Receiving Material

(76) Inventors: Ian M. Newington, Buckinghamshire (GB); John M. Higgins, Middlesex (GB); Stephanie M. Reignier, Clemont Ferrand (FR)

Correspondence Address: EASTMAN KODAK COMPANY;PATENT LEGAL STAFF, 343 STATE STREET, ROCHESTER, NY, 14650-2201, US

(21) Appl. No.: 10/592,728

(22) PCT Filed: Mar. 22, 2005
(86) PCT No.: PCT/GB2005/001058

§ 371 Date: Sep. 14, 2006

(30) Foreign Application Priority Data
Mar. 24, 2004 (GB) 0406981.1

(51) Int. Cl. B05D 5/04; B41M 5/00

(52) U.S. Cl. 428/32.32; 428/32.1; 427/331

(57) ABSTRACT

A porous polymeric ink-jet receiver prepared by generating an emulsion comprising a first phase having a first carrier fluid and a second phase having a second carrier fluid, said first and second carrier fluids being immiscible; coating the emulsion onto a support; carrying out a first treatment to at least one component of the first phase to form and/or maintain a skeletal structure of the treated at least one component of the first phase; and carrying out a second treatment to the second phase to substantially remove the carrier fluid thereby generating a large capacity porous structure defined by the skeletal structure is capable of rapid uptake of large quantities of ink, especially when using a high internal phase water-in-oil emulsion.

### FIELD OF THE INVENTION

The present invention relates to ink-jet receivers and a method of malting ink-jet receivers. More particularly, the invention is concerned with improved ink-receiving layers having rapid ink uptake and large capacity and to methods of making such ink-receiving layers in ink-jet receivers. More specifically, the present invention relates to the use of emulsions to generate porous ink-jet receivers.

### BACKGROUND OF THE INVENTION

Ink-jet receivers are generally classified in one of two categories according to whether the principal component material forms a layer that is “porous” or “non-porous” in nature. Many commercial photo-quality porous receivers are made using a relatively low level of a polymeric binder to lightly bind inorganic particles together to create a network of interstitial pores which absorb ink by capillary action. These receivers can appear to dry immediately after printing. However, relatively thick layers are usually required, sometimes as much as 50 μm, to provide sufficient fluid capacity. As the component materials are relatively dense, large masses of material are needed and the layers are often prone to cracking and brittleness.

Non-porous receivers are made up of polymeric layers that are capable of absorbing relatively large amounts of ink by molecular diffusion. The main problem with this type of receiver is that the diffusion process is relatively slow and the receivers can take a considerable time before they appear dry.

A porous polymer material may be a suitable material for use in an inkjet receiver. Methods for making porous polymer materials have been known for some time, although difficulties in conveniently making porous materials with suitable physical properties, without involving the use of significant quantities of volatile organic materials, particularly to create porosity, would be likely to prove disadvantageous in making ink-jet receivers, especially in large scale manufacture.

However, porous polymeric foams obtained by polymerising a polymerisable monomer in a high internal phase emulsion (HIPE) are known and their use as industrial filters, as supports in synthesis and cell growth and as absorbent materials for sanitary articles has been described.

WO-A-97/37745 describes a method of preparing a filter material, for use as a bag filter, for example, by impregnating a high internal phase emulsion, comprising a polymerisable monomer in the continuous phase, into a porous substrate, such as a felt material, and polymerising the polymerisable monomers to form a cured foam within the felt material. The filter material formed can comprise mean pore sizes of between about 1 and 100 μm. The small pore size and high degree of porosity of the material formed results in a significant reduction in the pressure drop across the filter material.

U.S. Pat. No. 5,817,704 describes a HIPE-derived heterogeneous polymeric foam structure of interconnecting cells, obtained by polymerising polymerisable monomers from at least two distinct HIPEs in a mixture, for use to absorb and store liquids in sanitary articles.

WO-A-97/27240 describes a method of preparing foams from HIPEs by coating a HIPE continuously onto a continuous moving strip of relatively inert polymeric film, such as polypropylene, spooling the coated polymeric film and heat curing the HIPE on the coated, spooled film. The foam can then be unspooled and removed from the polymeric film.

It is desirable to form an ink-receiving layer for an inkjet receiver which absorbs large quantities of ink rapidly. It is further desirable that the ink-receiving layer is sufficiently thin that the sharpness of the printed image is maintained. It is still further desirable that an ink-receiving layer provides good light and environmental stability for the printed image.

### PROBLEM TO BE SOLVED BY THE INVENTION

It is, therefore, an object of the invention to provide a novel method of making an ink-receiving layer for an inkjet receiver, which enables rapid uptake of ink and provides high capacity.

It is a further object of the invention to prepare such an ink-receiving layer economically and efficiently and, therefore, from the minimum of material.

### SUMMARY OF THE INVENTION

According to a first aspect of the invention there is provided a process for the preparation of an ink-jet receiver having a liquid-receiving layer with a high liquid-absorption rate, said process comprising generating an emulsion comprising a first phase having a first carrier fluid and a second phase having a second carrier fluid, said first and second carrier fluids being immiscible; coating the emulsion onto a support; carrying out a first treatment to at least one component of the first phase to form and/or maintain a skeletal structure of the at least one component of the first phase in the emulsion; and carrying out a second treatment to the second phase to substantially remove the second carrier fluid thereby generating a large capacity porous structure defined by the skeletal structure for rapid uptake of ink.

In a second aspect of the invention, there is provided an ink-jet receiver comprising a porous cross-linked polymeric liquid-receiving layer obtainable by the above process.

In a third aspect of the invention, there is provided a use of an emulsion to form a porous cross-linked polymeric liquid-receiving layer for an ink-jet receiver by coating the emulsion onto a support, treating at least one phase of the emulsion to form a skeletal polymer structure and removing at least one other phase of the emulsion.

In a fourth aspect of the invention, there is provided the use of high shear applied to an emulsion to control the pore size of a porous cross-linked polymeric material prepared therefrom.

In a fifth aspect of the invention, there is provided a method of printing, said method comprising the steps of providing an ink-jet printer responsive to electronic data signals, loading the ink-jet printer with an ink-jet receiver as defined above and causing electronic data signals, corresponding to a desired image to be printed, to be sent to the ink-jet printer, said ink-jet printer responding by printing the image onto the ink-jet receiver.

### ADVANTAGEOUS EFFECT OF THE INVENTION

The process of the present invention provides an ink-jet receiver that is capable of rapid uptake of large amounts of ink due to the large internal, open-cell capacity formed within the skeletal structure of the porous cross-linked polymer formed.

### BRIEF DESCRIPTION OF THE DRAWINGS

FIG. 1 shows a cross-sectional Scanning Electron Micrograph (SEM) of a conventional porous polymeric material obtained by heat-curing, in a mold, a high internal phase emulsion (HIPE) formed by a conventional low shear process;

FIG. 2 shows a cross-sectional SEM of a porous polymeric liquid-receiving layer of an ink-jet receiver prepared by heat curing a HIPE-coated support, according to the present invention.

FIG. 3 shows a graph of drop volume (picolitres) versus time (milliseconds), which illustrates the rate of absorption of a porous polymeric liquid-receiving layer of an ink-jet receiver prepared by heat curing a HIPE-coated support according to the present invention.

FIG. 4 shows a graph of drop volume (picolitres) versus time (milliseconds), which illustrates the rate of absorption of a swellable polymeric liquid-receiving layer according to Comparative Example 1.

FIG. 5 shows a graph of drop volume (picolitres) versus time (milliseconds), which compares the rate of absorption of a porous polymeric liquid-receiving layer of an inkjet receiver prepared by heat curing a HIPE-coated support according to the present invention, with two commercially available ink-jet receivers.

FIG. 6 shows a cross-sectional SEM of a porous polymeric liquid-receiving layer of an ink-jet receiver prepared by heat curing a HIPE-coated support, according to the present invention in which the HIPE is mixed at a shear rate of 2000 rpm.

FIG. 7 shows a cross-sectional SEM of a porous polymeric liquid-receiving layer of an ink-jet receiver prepared by heat curing a HIPE-coated support, according to the present invention in which the HIPE is mixed at a shear rate of 4000 rpm.

FIG. 8 shows a cross-sectional SEM of a porous polymeric liquid-receiving layer prepared by heat curing a HIPE-coated support, according to the present invention in which the HIPE is mixed at a shear rate of 6000 rpm.

FIG. 9 shows a graph of mean pore diameter (μm) versus shear rate (rpm) for porous polymeric liquid-receiving layers of ink-jet receivers prepared by heat curing a HIPE-coated support, according to the present invention.

FIG. 10 shows a cross-sectional SEM of a porous polymeric liquid-receiving layer of an ink-jet receiver prepared by heat curing a HIPE-coated support according to the present invention, which HIPE contained a porogen in the continuous phase.

FIG. 11 shows a top view SEM of a porous polymeric liquid-receiving layer of an ink-jet receiver prepared by heat curing a HIPE-coated support according to the present invention, in which the polymerisation initiator precursor was AIBN.

FIG. 12 shows a top view SEM, at a magnification of 5000×, of a porous polymeric liquid-receiving layer of an ink-jet receiver prepared by heat curing a HIPE-coated support according to the present invention, in which the HIPE was coated onto the support by extrusion coating.

FIG. 13 shows a cross-sectional SEM, at a magnification of 625×, of a porous polymeric liquid-receiving layer of an ink-jet receiver prepared by heat curing a HIPE-coated support according to the present invention, in which the HIPE was coated onto the support by extrusion coating.

FIG. 14 shows a top view SEM, at a magnification of 5000×, of a porous polymeric liquid-receiving layer of an ink-jet receiver prepared by heat curing a HIPE-coated support according to the present invention, in which the HYPE was coated onto the support by extrusion coating at a slow extrusion rate (7 ml/min).

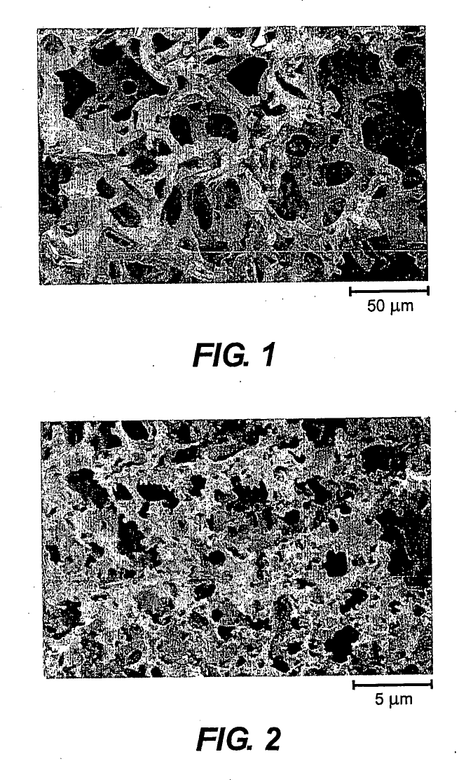

### DETAILED DESCRIPTION OF THE INVENTION

The emulsion used to put the present invention into effect is preferably a biphasic emulsion, typically comprising two liquid phases, which may be two immiscible oil phases, but is preferably a water-in-oil or an oil-in-water emulsion. One of the phases may be treated to form an integral or skeletal structure such that on removal of the other phase, or of a large portion, for example the carrier fluid, of the other phase of the emulsion, the integrity of the structure of the first phase in the emulsion is largely maintained, thereby forming a porous structure useful for rapid uptake of liquid.

Preferably one of the phases of the emulsion—the phase to be treated such that a skeletal structure is formed—comprises a polymerisable monomer which may be treated by initiating a polymerisation reaction to form an integral polymeric structure throughout that phase, which structure remains largely intact on removal of the carrier fluid of the other phase. Alternatively, the phase of the emulsion to be treated such that a skeletal structure is formed may comprise a soluble polymer, which may be treated by initiating a cross-linking reaction. Suitable soluble polymers include polymers of intrinsic microporosity (PIMs) such as those described in McKeown et al (J. Chem. Soc., Chem. Commun., 2004, 230-231), the disclosure of which is incorporated herein by reference.

In a preferred embodiment of the invention, the emulsion used according to the present invention is a high internal phase emulsion (HIPE). A high internal phase emulsion is a term known in the art and refers to emulsions in which the internal phase is present in an amount greater than would normally be expected, according to spherical close-packing, before inversion of the phases occurs. For example, under normal circumstances, in an oil-in-water emulsion, when the amount of the internal phase (in this case, oil) exceeds 75.04% by volume, the emulsion would undergo phase inversion to form a water-in-oil emulsion, or vice versa. A high internal phase emulsion is an emulsion which, for some reason, when the internal phase exceeds 75.04% does not undergo phase inversion.

Usually such high internal phase emulsions require stabilisation to prevent phase inversion. For example, the emulsion may be stabilised by incorporating a suitable surfactant into the emulsion.

According to the preferred embodiment, the continuous phase (external phase) of the high internal phase emulsion preferably comprises a component, such as a polymerisable monomer, which may be treated, for example by initiating a polymerisation reaction, so that a skeletal structure is formed which substantially maintains the geometrical form of the continuous phase of the emulsion. The carrier fluid of the internal phase may then be removed to reveal a highly porous skeletal structure capable of absorbing a large amount of ink. Such a skeletal structure prepared from a HIPE shall be referred to herein as a polyHIPE structure.

A particular advantage of treating the continuous phase of a high internal phase emulsion to form a skeletal structure for use as a liquid-receiving layer of an ink-jet receiver, besides the advantage of having a structure with a large capacity for ink, is that the internal phase of a high internal phase emulsion defines cavities with a high degree of interconnectivity. Particular advantages of this are that the carrier fluid of the internal phase can be rapidly removed from the structure formed by treatment of the continuous phase and that it allows the rate of fluid uptake by the remaining structure to be significantly increased.

When a high internal phase emulsion is formed from an aqueous phase and an oil phase, an oil-in-water HIPE (high internal phase emulsion) may be used in which a component in the aqueous phase is treated to form an integral structure defined by the structure of the aqueous phase in the emulsion. Preferably, however, a water-in-oil HIPE is utilised.

According to the embodiment of the invention in which a water-in-oil HIPE is utilised, a component of the oil phase, which may be the carrier fluid, is preferably a polymerisable monomer that may be treated by initiating a polymerisation reaction.

The polymerisable monomer may be any suitable monomer capable of forming a polymer under reaction conditions that can be carried out in an emulsion. Suitable monomers for use according to the present embodiment include monomers having a polymerisable-vinyl group such as: monoalkenyl arene monomers, for example α-methylstyrene, chloromethylstyrene, vinylethylbenzene and vinyl toluene; acrylate and methacrylate esters, for example 2-ethylhexyl acrylate, n-butyl acrylate, isobutyl acrylate, t-butyl acrylate, hexyl acrylate, n-butyl methacrylate, lauryl methacrylate, and isodecyl methacrylate; conjugated diolefins such as butadiene, isoprene, and piperylene; allenes, for example allene, methyl allene and chloroallene; olefin halides, for example vinyl chloride, vinyl fluoride; and polyfluoro-olefins. A preferred polymerisable monomer according to the present invention is styrene. In any case, it is preferable that the polymerisable monomer according to the present embodiment has a low solubility in water, and more preferably is insoluble in water.

Optionally, the oil phase may comprise two or more polymerisable monomers, which monomers may, for example, be selected from the above list of monomers, so as to form a copolymer therefrom following the polymerisation reaction.

Preferably, in order to confer a degree of rigidity into the skeletal structure formed, a cross-linker may be incorporated into the oil phase. Suitable cross-linking agents may be any multifunctional unsaturated monomer capable of reacting with the polymerisable monomer. Such cross-linking agents contain at least two functional groups, which functional groups may be selected from, for example, vinyl groups, acrylate groups and methacrylate groups. The cross-linking monomers may include, for example, difunctional unsaturated cross-linking monomers such as divinylbenzene, diethylene glycol dimethacrylate, 1-3-butanediol dimethacrylate, and allyl methacrylate and tri-, tetra- and penta-functional unsaturated cross-linking monomers such as trimethylolpropane trimethacrylate, pentaerythritol tetramethacrylate, trimethylolpropane triacrylate and pentaerythritol tetra-acrylate, glucose pentaacrylate, glucose diethylmercaptal pentaacrylate, and sorbitan triacrylate; and poly-functional unsaturated cross-linking monomers such as polyacrylates (e.g. sucrose per(meth)acrylate and cellulose (meth)acrylate). The preferred cross-linkers are divinyl benzene and 1,4-butanediol dimethacrylate, preferably divinyl benzene. En order to achieve an acceptable balance between the degree of rigidity of the integral structure and the flexibility of the ink-jet receiver formed so that both the integral structure and the ink-jet receiver formed are suitably resilient, the relative amount of cross-linker to polymerisable monomer is preferably in the range of from 0.5 wt % (weight percent) to 70 wt %, more preferably from 2 wt % to 40 wt % and still more preferably from 5 wt % to 20 wt %.

Specific properties, including rate of polymerisation, flexibility, bulk, rigidity and brittleness may be controlled by varying the relative amounts of polymerisable monomers and of cross-linking agent and may depend on the specific identity of these components.

According to the present embodiment, in which a water-in-oil HIPE is utilised and the oil phase comprises a polymerisable monomer, the first treatment carried out to the at least one component (the polymerisable monomer) so that a skeletal structure is formed, is the initiation of a polymerisation reaction.

The initiation of the polymerisation reaction may be by simply heating the emulsion comprising a polymerisable monomer composition, by irradiation with UV or other electromagnetic irradiation, but preferably the initiation of the polymerisation reaction comprises heating the emulsion to form a polymerisation initiator species, e.g. a radical initiator, from an initiator precursor present in the emulsion. Examples of suitable initiator precursors include oil soluble initiator precursors and water soluble initiator precursors. Suitable water soluble initiator precursors include, for example, persulfates such as potassium or sodium persulfate, and redox coupler initiator systems such as ammonium persulfate together with sodium metabisulfite. Suitable oil soluble initiator precursors include, for example, azo compounds such as azobisisobutyronitrile; and peroxides such as benzoyl peroxide, methyl ethyl ketone peroxide, allylperoxycarbonates such as di-2-ethylhexyl peroxy-dicarbonate and di(sec-butyl)peroxydicarbonate and allyl peroxycarboxylates such as t-butyl peroxyisobutyrate, 2,5-dimethyl-2,5-bis(2,3-ethylhexanoylperoxy)hexane, and t-butyl peroctoate. Preferable alkylperoxycarbonates are branched at the 1-position and preferable alkylperoxycarboxylates are branched at the α-position and/or 1-position. Examples of branched alkylperoxycarbonates and alkylperoxycarboxylates are described in WO-A-9737745 (page 8, line 14 to page 9, line 5), which disclosure is incorporated herein by reference. The preferred initiator precursor according to the present invention are one or more of potassium persulfate, AIBN (azobisisobutyronitrile), and a redox couple initiator system comprising, for example, ammonium persulfate and sodium metabisulfite. The initiator precursor may form part of the oil phase (e.g. AIBN) or the aqueous phase (e.g. potassium persulfate or an aqueous redox coupling system) or both (e.g. AIBN in the oil phase and potassium persulfate in the aqueous phase), but preferably the initiator precursor forms part of the aqueous phase. Without being bound by theory, it is believed that by initiating the polymerisation reaction using an initiator in the aqueous phase, the polymer is first formed at the boundary between the oil and aqueous phases leading to better maintenance of the integral structure of the oil phase on completion of the polymerisation reaction, as compared with an initiator in the oil phase which may result in some distortion of the integral structure of the emulsion on completion of the reaction.

Nevertheless, it may be that the presence of an initiator precursor in both the oil phase and the aqueous phase may be preferred in order to ensure more rapid completion of the polymerisation reaction, which may be of particular benefit from a large scale manufacturing point of view.

The amount of the initiator precursor present and the temperature applied determines the average chain length in linear polymer systems; the more initiator, the more radicals are generated at any one time. Preferably, the initiator precursor is present in an amount of from 0.5 to 10 wt %, more preferably 1 to 7 wt % and most preferably 3 to 5 wt % based on the amount of polymerisable monomer present.

The temperature applied during the polymerisation step (or curing step) is preferably in the range 40-120° C., more preferably 50-90° C. and most preferably 60-80° C. The time for the polymerisation step is typically inversely related to the temperature applied. For example, in a preferred embodiment, the polymerisation stage involves heating to 65-70° C. for a period of 4-6 hours. After the polymerisation step, the polyHIPE material formed is preferably treated, by drying, in order to remove water by evaporation. Preferably the polyHIPE is dried at 65-70° C. for 2-4 hours.

As mentioned above, a high internal phase emulsion is usually stabilised by a surfactant. For water-in-oil emulsions, it is necessary for the surfactant to be soluble in the oil phase and suitable such surfactants may be determined according to the hydrophilic-lipophilic balance (HLB value) of a surfactant. Typically, suitable surfactants have very limited solubility in the internal phase (e.g. the aqueous phase of a water-in-oil emulsion) in order that they can adequately stabilise the high internal phase emulsion and prevent phase inversion occurring spontaneously. Preferably, the surfactant has an HLB value in the range of from 2 to 6 and preferably is about 4. The surfactant may be non-ionic, cationic, anionic or amphoteric provided that the surfactant or combination of surfactants are effective to form a stable high internal phase emulsion. Preferred types of surfactants that can be used to stabilise water-in-oil HIPEs include sorbitan fatty acid esters, polyglycerol fatty acid esters, polyoxyethylene fatty acids and esters. Examples of sorbitan fatty acids esters include sorbitan monolaurate (available as SPAN® 20), sorbitan monooleate (SPAN® 80) and combinations of sorbitan monoleate (SPAN® 80) with sorbitan trioleate (SPAN® 85). One such surfactant combination of sorbitan fatty acid esters is the combination of sorbitan monooleate and sorbitan trioleate in a weight ratio greater than or equal to 3:1, more preferably 4:1. Other suitable surfactants are “TRIODAN® 20”, which is a polyglycerol ester available from Grindsted®, and “EMSORB® 252”, which is a sorbitan sesquioleate available from Henkel®.

Preferred surfactants according to the preferred embodiment of the invention include, for example, sorbitan monooleate and glycerol monooleate. Sorbitan monooleate is a particularly preferred surfactant because it can also act as an ozone scavenger which has the benefit that in the resulting ink-jet receiver, the surfactant can help postpone the onset of any ozone induced fade.

The surfactant may be present in the emulsion in an amount of from 1 to 50 wt %, preferably 5 to 40 wt %, more preferably 15 to 40 wt %, still more preferably 20 to 35 wt % and most preferably 25 to 33 wt % based on the amount of polymerisable monomer present. Where sorbitan fatty acid esters are used as a component of the surfactant, the sorbitan fatty acid ester surfactants are preferably present in an amount of from 2 to 36 wt %, more preferably from 5 to 25 wt %.

Preferably, according to the present embodiment of the invention in which a water-in-oil HIPE is utilised, the oil phase comprises a polymerisable monomer, a surfactant and optionally a cross-linker. The carrier fluid may be the polymerisable monomer or a mixture of the components or may be an additional solvent, but preferably comprises the polymerisable monomer. The aqueous phase comprises water, as the carrier fluid, and optionally an electrolyte, for additional stabilisation of the emulsion.

Suitable electrolytes include inorganic salts (monovalent, divalent, trivalent or mixtures thereof), for example, alkali metal salts, alkaline earth metal salts and heavy metal salts, which may be halides, sulfates, carbonates, phosphates and mixtures thereof. Preferably, a suitable electrolyte comprises one or more of sodium chloride, sodium sulfate, potassium chloride, potassium sulfate, lithium chloride, magnesium chloride, calcium chloride, magnesium sulfate and aluminium chloride. Preferably, the electrolyte is calcium chloride.

Additional components may be added to the second phase according to the present invention to provide improved properties to the resulting liquid-receiving layer of the ink-jet receiver. Such additional components may be, for example, swellable polymers or other materials capable of absorbing ink and/or protecting the ink from environmental factors. By incorporating such additional components into the second phase of the emulsion, these components may be evenly coated onto the surface of the skeletal structure on removal of the second carrier fluid. Where the second phase is an aqueous phase, such as in the preferred embodiment of the invention utilising a high internal phase water-in-oil emulsion, additional components that may be included in the aqueous phase to improve the properties of the resulting liquid-receiving layer of the inkjet receiver include, for example, polyvinyl alcohol (PVA) or other aqueous soluble swellable polymer material, so that on removal of the second carrier fluid (water), the PVA or other polymer material forms a thin coating on the internal surface of the resultant skeletal polymer structure. Such a coating of PVA or other swellable polymer material may provide a protective environment within the porous liquid-receiving layer for ink rapidly absorbed into the structure, especially when the liquid-receiving layer is the ink-receiving layer. Similarly, a coating of a mordant material may be formed by incorporating a mordant into the second phase. Examples of useful mordants, for stabilising absorbed ink and improving image density, include [3-(methacryloylamino)propyl]trimethylammonium chloride.

Other additional components that may be added to the second phase include, for example, stabilisers for dyes and/or pigments against degradation by, for example, light or ozone, UV absorbers, sequestering agents, surfactants, polymeric binders, etc.

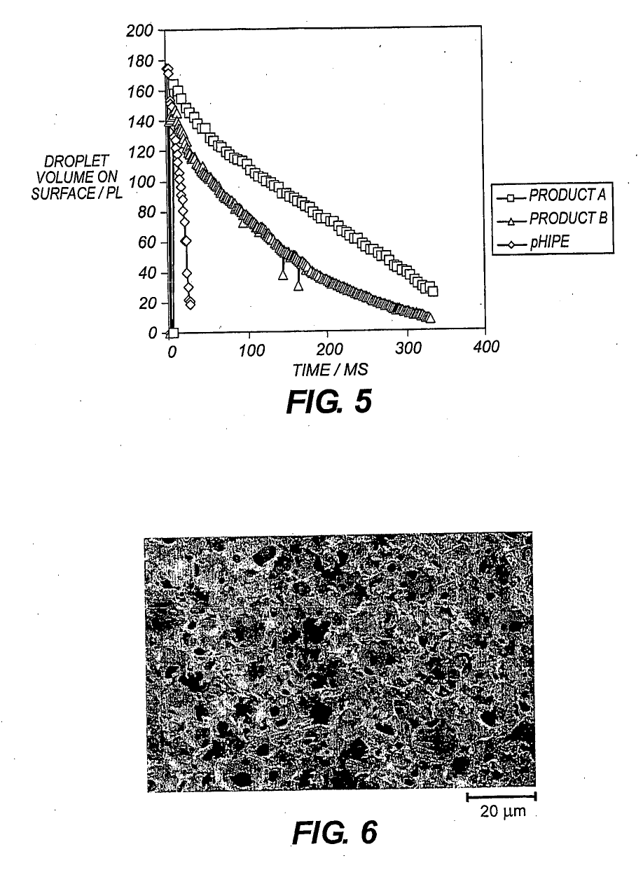

The inventors have found that HIPEs can be coated as a thin layer onto a support and treated to form a polyHIPE liquid-receiving layer of an ink-jet receiver, especially an ink-receiving layer. PolyHIPE materials have been found to be advantageous for use as liquid-receiving layers in inkjet receivers and especially as ink-receiving layers because of their rapid rate of ink absorption and their high internal capacity, both of which features are highly beneficial for an ink-receiving layer material, because a large amount of ink can be absorbed rapidly allowing the ink-jet receiver to appear dry almost immediately. See, for example, the graphs in FIG. 5, which compare the rate of drying of an ink-jet receiver made according to the present invention and two commercially available receivers. This prevents the smudging of images on the inkjet receiver, or even partial transfer onto other surfaces, allowing the printed image to be handled without delay.

Another advantage is that due to the high internal capacity of polyHIPE liquid- or ink-receiving layers, a much thinner layer is required to absorb a certain amount of ink. The benefit of this is that less material is required to form the inkjet receiver, manufacturing is easier and the physical quality of the ink-jet receiver is improved. Table 1 illustrates the effect of porosity on the volume of material and layer thickness sufficient to absorb 25 ml/m² of ink, the values corresponding to estimated values of various types of ink-jet receivers mentioned in the comments column.

TABLE 1
Layer thickness and volume of material required to contain 25 ml/m² of
ink for ink-receiving layers of a range of porosities.

| Porosity | Volume of Material | Layer Thickness | |
|---|---|---|---|
| (as %) | (ml m⁻²) | (μm) | Comment |
| 25% | 75.0 | 100.0 | Close-packed |
| | | | particulate |
| | | | structures |
| 30% | 58.3 | 83.3 | \| |
| 40% | 37.5 | 62.5 | ↓ |
| 50% | 25.0 | 50.0 | Typical Commercial |
| | | | Receiver |
| 60% | 16.7 | 41.1 | ↓ |
| 70% | 10.7 | 35.7 | |
| 80% | 6.3 | 31.3 | Poly(HIPE) |
| 90% | 2.8 | 27.8 | ↓ |

The porosity of the material forming the liquid-receiving layer according to the present invention depends upon several factors. In particular, the porosity depends upon the relative amounts of the first and second phases of the emulsion from which the liquid-receiving skeletal structure is formed, since the pores are defined by the second phase of the emulsion, the carrier fluid of which is removed during the process of forming the liquid-receiving layer. For example, for a water-in-oil HIPE to result in a polyHIPE material with a porosity of 80%, it is required that the HIPE comprises 20% oil phase and 80% aqueous phase. Therefore, by increasing the relative amount of the second phase in the emulsion, the porosity of the resultant liquid-receiving layer may also be increased.

It further depends upon the quantity of addenda included in the second phase.

The porosity of the skeletal structure formed may be further increased by incorporating a porogen into the first phase of the emulsion (e.g. the oil phase of a water-in-oil HIPE, according to the preferred embodiment). The degree of porosity may be controlled according to the amount of and the identity of the one or more porogens used. Examples of suitable porogens include any organic solvent soluble in the oil phase but not substantially water soluble and the precise identity may depend upon the polymerisable monomer used, but examples might include hexane, cyclohexane, heptane and, preferably, toluene.

Preferably the polyHIPE formed according to the preferred embodiment of the present invention has a porosity of at least 26%, such as within the range 30-95%, and more preferably in the range 40-90%. In a preferred example, the polyHIPE formed may have a porosity in the range 60-85%.

Preferably, the liquid-receiving layer described above in accordance with the present invention, is an ink-receiving layer of an ink-jet receiver.

An ink-receiving layer according to the present invention, and particularly the preferred embodiment of the invention in which a water-in-oil HIPE is utilised, is preferably formed having a thickness of 200 μM or less, more preferably 100 μm or less, still more preferably 50 nm or less and most preferably in the range of from 5 μm to 45 μm, the precise thickness depending also upon the degree of porosity of the ink-receiving layer formed, the design of the ink-jet receiver and the type and amount of ink to be used to print onto the ink-jet receiver.

According to the present invention, the emulsion may be coated onto the support, or as part of a multi-layer structure, by any suitable coating method. For example, the emulsion may be coated by blade, knife or extrusion coating techniques. One method of coating found to be effective is blade coating. However, perhaps a preferred method of coating the emulsion would be by an extrusion coating technique and should this method be utilised, the rate of extrusion may affect the resultant structure of the porous polymer material in that at a low rate of extrusion, the structure of the resultant material may be similar to that obtained via blade coating, whilst at a higher rate of extrusion, a modified structure may result, which still has an excellent rate of absorption and fluid capacity. For example, a relatively higher rate of extrusion may result in a modified structure—see, for example, the polyHIPE structure in FIG. 12. An intermediate rate of extrusion may result in an intermediate modified structure of the porous polymer material—see, for example, the polyHIPE structure in FIG. 14.

Suitable supports for use in the present invention include any suitable support for an ink-jet receiver, such as resin-coated paper, film base, acetate, polyethylene terephthalate (PET), a printing plate support such as aluminium foil, a latex-treated polyester or any other suitable support. Aluminium foil and latex-treated polyester have been found to be particularly effective supports for use in the preferred embodiment of the present invention in which a porous polymeric ink-receiving layer is formed using a water-in-oil HIPE.

Preferably, after coating of the emulsion onto the support, there is some means of preventing either of the carrier fluids from evaporating in substantial amounts before or during the step in which the first phase is treated. For example, in the case of a water-in-oil HIPE, there is some means of preventing evaporation of water, which could cause the emulsion to collapse, before or during the polymerisation step. One method of achieving this is to laminate the coated support, for example with a temporary plastic laminate material or with a sheet of glass, which can be removed after the polymerisation step.

The average pore size of the skeletal structure formed according to the present invention, especially in respect of the preferred embodiment in which a polyHIPE material is formed from a water-in-oil HIPE, is preferably up to about 10 μm diameter, more preferably up to 1 μm, still more preferably up to 0.1 μm and most preferably in a range from 10 to 90 nm, and perhaps within a range of from 20 to 80 nm, or from 25 to 60 nm.

A particular advantage of having a skeletal structure with a small pore size, especially a pore size of 0.1 μm or less, is that ink or other material to be absorbed can be absorbed much more quickly because of improved capillary action. Another important advantage of having a small pore size is that the skeletal structure, e.g. a polyHIPE material, when used as an ink-receiving layer can appear much more glossy if the pore size is relatively small. A further advantage of having a smaller pore size is that the emulsion from which the skeletal structure is formed is better dispersed and therefore has improved stability which makes coating the emulsion onto a support easier and makes coating the emulsion in a thin layer, e.g. 100 μm or less, possible.

The inventors have found that the shear to which the emulsion is subjected can be used to control the pore size of the resultant skeletal structure, and in particular, when using a mixer, the shear rate during mixing, for example in a Polytron™ high shear mixer, can be used to control the pore size in the resultant material.

For example, in a water-in-oil HIPE according to the preferred embodiment of the invention, an increase in the shear rate of mixing applied to the emulsion prior to coating onto a support, of from 2000 to 6000 rpm resulted in a substantial decrease in pore size, as can be seen from FIGS. 6 to 9, without significantly affecting the overall pore volume of the resultant liquid-receiving layer.

Preferably, therefore, the process of generating an emulsion according to the present invention, comprises mixing the phases in a mixer with a high shear rate, having a shear rate of, for example, greater than 1000 rpm, preferably greater than 2000 rpm, for example, in the range from 4000 rpm to 6000 rpm, but preferably at least 6000 rpm and more preferably at least 7000 rpm.

When preparing the emulsion, especially in large quantities, it may be beneficial to mix the emulsion at a first shear rate in order to establish an adequately mixed emulsion for a first period and then increase the shear rate to a rate according to the porosity desired in the resultant material as discussed above, for a second period rather than maintain the higher shear rate for the entire mixing time in order to prevent heat generated during the mixing process causing the polymerisation step to begin or to proceed to any great degree.

According to a preferred embodiment of the fourth aspect of the invention, there is provided the use of the shear rate of mixing an emulsion to control the pore size of a skeletal structure formed by treating a first phase of the emulsion to form the skeletal structure and removing a carrier fluid from a second phase. The use of the shear rate to control the pore size is particularly applicable to the formation of a porous polymer foam formed by polymerisation of a HIPE comprising a polymerisable monomer in the continuous phase (first phase). In particular, the use of a shear rate of, for example, 4000 to 6000 rpm may control the pore size of the porous polymer foam, or polyHIPE, formed to less than 5 μm and an increase in shear rate of from 2000 to 6000 rpm, for example, may result in pores being reduced in size from greater than 10 μm to less than 5 μM. The use of a shear rate of greater than 7000 may be used to control the pore size to be less than 1 μm. The control of pore size to be relatively small, e.g. 0.1 μm or less, for example, within the range 10 to 80 nm, may be beneficial in a variety of uses of such porous polymer foams. Such uses might include, for example, polymer foams as filters to remove from a fluid stream very small particles, of dimensions similar to the average pore size of the polymeric foam. The ability to control the pore size to be very small, e.g. within the range 10 to 80 nm is especially useful in forming an ink-receiving layer of an ink-jet receiver.

Preferably, as mentioned above, the liquid-receiving layer is the ink-receiving layer and dyes in the ink may be retained by the material in that layer. The ink-jet receiver may comprise of only a support and the above described liquid-receiving layer as the ink-receiving layer and, optionally, a top coat.

Optionally, in a further aspect of the invention, the porous cross-linked polymeric layer described above, especially the polyHIPE materials, may form part of a multi-layer structure having further layers above the porous cross-linked polymeric layer and/or below (i.e. between the porous cross-linked polymeric layer and the support). For example, the ink-jet receiver may comprise an additional layer below the porous cross-linked polymeric layer to improve adhesion between that layer and the support. The receiver may also comprise a further layer above the porous cross-linked polymeric layer described above, which may be a thinner (typically, more expensive) top layer. Such a top layer preferably has a glossy appearance and may be a relatively non-porous swellable polymer layer or, preferably, also has some porous character. Such a top layer may optionally be the ink-receiving layer, the porous cross-linked polymer layer being a liquid-receiving layer capable of retaining large quantities of liquid. Examples of porous ink-receiving layers that may suitably coated onto an ink-receiving layer as described above to provide a multi-layer ink-jet receiver include those porous ink-receiving layers comprising inorganic particulate materials and polymeric binders described in US-A-20020142140, US-A-20020142139 and US-A-20020142138, the disclosures of which are incorporated herein by reference.

In one embodiment of a multi-layer ink-jet receiver comprising a porous cross-linked polymeric layer described above, especially a polyHIPE liquid-receiving layer, the receiver comprises more than one layer of the porous cross-linked polymeric material of this type, each layer having a similar, but preferably a different, porosity and pore size, in a controlled manner such that ink may permeate through the layers of the receiver. The use of shear rate as described above may effectively control the variation of pore size in successive layers of the polymeric layers of the inkjet receiver. Such a multi-layer structure may still further comprise a porous or non-porous overcoat as set out above.

According to a still further aspect of the invention there is provided an inkjet receiver having an ink-receiving layer which ink-receiving layer comprises a polyHIPE material. The polyHIPE material as ink-receiving layer preferably has a thickness of 200 μm or less, more preferably 100 μm or less.

According to a still further aspect of the invention, there is provided a use of a polyHIPE material in an ink-receiving layer of an ink-jet receiver. In each of these further aspects of the invention, the polyHIPE material may be prepared according to any suitable method and preferably by the method described above and may incorporate additional variants and features described.

The invention will now be described by way of example only and without limitation as to the scope of the invention in the following Examples.

### EXAMPLES

### Example 1

Styrene (9 ml) and divinyl benzene (1 ml, 55% purity) were mixed with sorbitan monooleate (3 ml) in a 500 ml wide-mouth plastic bottle and stirred with a Polytron high shear mixer at 4000 rpm under a blanket of nitrogen gas. A solution of calcium chloride (1 g) and potassium persulfate (0.4 g) in water (90 ml) that had been deoxygenated by bubbling nitrogen through it for 20 minutes was then added over approximately 30 minutes by peristaltic pump to the stirred monomers. During this addition, the stirrer head was raised as the volume in the bottle increased to ensure efficient mixing. After addition was complete, the mixture was stirred a further 10 minutes at 5000 rpm.

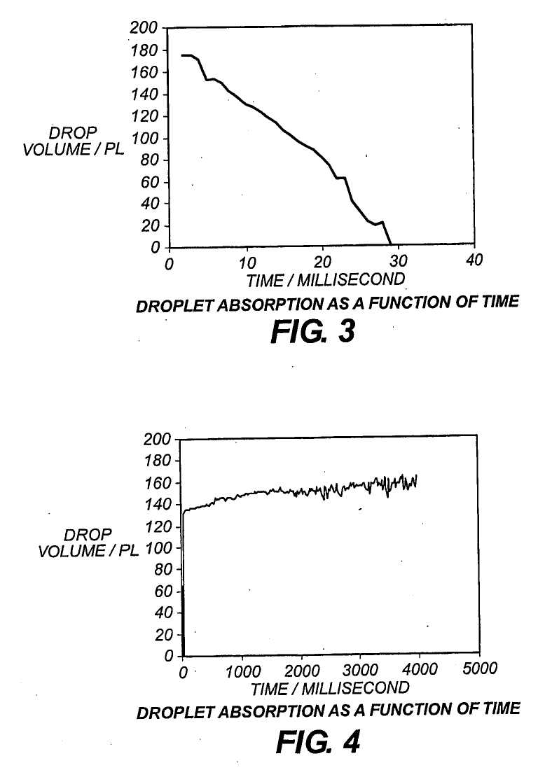

The HIPE formed was coated at 100 μm thickness onto aluminium foil, which was then laminated with a flat polyester sheet and cured in the oven at 70° C. for a minimum of 6 hours. The polyester laminate was removed and the coating allowed to dry at 60° C. for 2 hours. The resultant coating was examined by Scanning Electron Microscopy, a Scanning Electron Micrograph of a coating prepared according to Example 1 is shown in FIG. 2. Extremely rapid uptake of liquid was observed using the PISA device such that droplets were absorbed completely in about 30 milliseconds. A graph of droplet absorption as a function of time for a coating prepared according to Example 1 is shown in FIG. 3.

### Comparative Example 1

Styrene (4.5 ml), divinyl benzene (0.5 ml, 55% purity), sorbitan monooleate (1.5 ml) and initiator AIBN (azobisisobutyronitrile, 0.2 g) were mixed and degassed with bubbling nitrogen for 20 minutes. The mixture was blade-coated onto a polyester support at a thickness of approximately 100 μm and the coating heated in a nitrogen atmosphere at 65° C. for 12 hours. Ink absorption measurements, made with the PISA device, on the resultant tacky coating clearly show no ink absorption (FIG. 4) into the coating over four seconds.

### Example 2

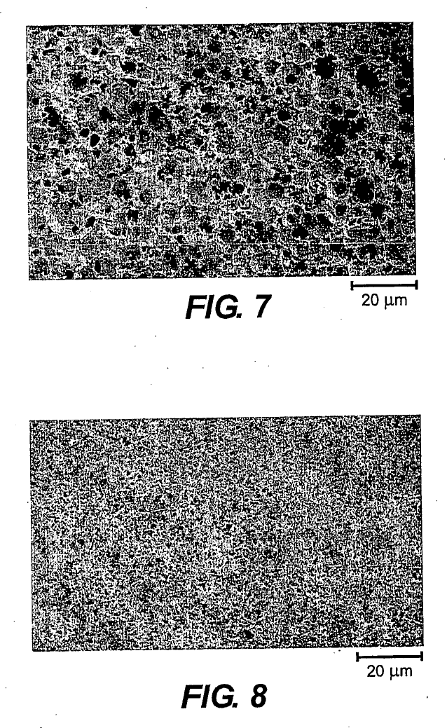

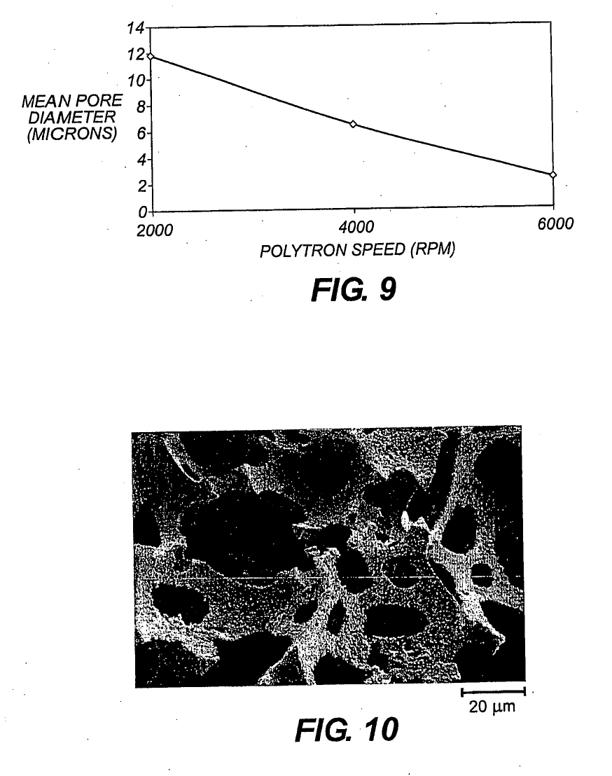

The effect of high shear stirring on the polymer structure was observed by preparing three coated polymer samples using the method of Example 1, except that each sample was prepared using a different shear rate. During the addition of the aqueous phase, the Polytron mixer was run at 2000, 4000 and 6000 rpm. SEM of the resultant samples clearly shows the reduction in size of the pore structure with increasing shear rate—see FIG. 6 (shear rate 2000 rpm), FIG. 7 (shear rate 4000 rpm) and FIG. 8 (shear rate 6000 rpm). FIG. 9 shows a graphical relationship between shear rate and mean pore diameter.

### Example 3

Styrene (4.5 ml), divinyl benzene (0.5 ml, 55% purity) and sorbitan monooleate (3 ml) were dissolved in toluene (5 ml) and degassed with nitrogen bubbling for 20 minutes. This mixture was stirred at 300 rpm with a 6-bladed impeller (38 mm diameter) while a nitrogen degassed solution of calcium chloride (1 g) and potassium persulfate (0.2 g) was added over approximately 1 hour by peristaltic pump. Stirring was continued for a further 5 minutes and then a sample of the emulsion was placed in an oven at 60° C. for 24 hours to cure, followed by heating under vacuum at 75° C. to dry. From SEM (FIG. 10) it can be seen that not only has the typical polyHIPE structure been formed but that the polystyrene itself is porous.

### Example 4

A polyHIPE coating was made following the method of Example 1 with replacement of water by a 1.1 wt % solution of PVA (MW 31-50,000, 98-99% hydrolysed) in water. The intermediate HIPE was stable and was hand-coated onto aluminium foil in the same manner as Example 1 to give a highly absorbent coating after curing at 70° C. for 15 hours.

### Example 5

The method of Example 4 was repeated using a 2.5 wt % PVA in water solution. The HIPE was knife coated onto aluminium foil, laminates with polyester and cured in the usual way to give a highly absorbent coating.

### Example 6

The method of Example 5 was repeated using a 5.6 wt % PVA in water solution to give a highly absorbent coating.

### Example 7

Following the method of Example 1, an aqueous solution comprising 80 ml potassium persulfate (0.4 g) and calcium chloride (1 g) in water mixed with 10 ml of 50 wt % [3-(methacryloylamino)propyl]-trimethylammonium chloride in water was added to styrene (9 ml), divinyl benzene (1 ml) and sorbitan monooleate (3 ml) under nitrogen. The resultant cationic polymer-containing HIPE was hand coated, laminated, cured and dried to give a highly absorbent coating.

### Example 8

In order to assess the effect of making a polyHIPE at low shear and the effect of partial pre-curing of the HIPE before coating to reduce propensity for stress cracking of said coating, an polyHIPE coated support was prepared as follows. Styrene (4.5 ml), divinyl benzene (0.5 ml, 55% purity) and sorbitan monooleate (3 ml) were mixed in a 250 ml plastic container and stirred at 300 rpm with a 6-bladed impeller (38 mm diameter) while a nitrogen degassed solution of calcium chloride (1 g) and potassium persulfate (0.2 g) was added over approximately 1 hour by peristaltic pump. Stirring was continued for a further 5 minutes and then the resultant HIPE in the plastic container was placed in an oil bath at 60° C. to cure. Samples were removed at time 0, 1.5 hours and 3 hours and coated onto glass, covered, then curing completed and the samples dried by heating under vacuum at 75° C. The sample without pre-curing collapsed completely, that pre-cured for 1.5 hours shrank considerably and did not produce a coherent coating whilst that pre-cured for 3 hours showed a highly absorbent, coherent coating.

### Example 9

The method of Example 1 was followed except that 1,4-butanediol dimethacrylate was used in place of divinyl benzene. A highly absorbent coating was produced.

### Example 10

The method of Example 1 was followed except that glycerol monooleate was used in place of sorbitan monooleate. A highly absorbent coating was produced.

### Example 11

Styrene (9 ml) and divinyl benzene (1 ml, 55% purity) were mixed with sorbitan monooleate (3 ml) and initiator AIBN (0.4 g, azo-bisisobutyronitrile) in a 250 ml wide-mouth plastic bottle and stirred with a Polytron high shear mixer at 4000 rpm under a blanket of nitrogen gas. A solution of calcium chloride (1 g) in water (90 ml) that had been deoxygenated by bubbling nitrogen through it for 20 minutes was then added over approximately 30 minutes by peristaltic pump to the stirred monomers. During this addition, the stirrer head was raised as the volume in the bottle increased to ensure efficient mixing. After addition was complete, the mixture was stirred a further 10 minutes at 5000 rpm.

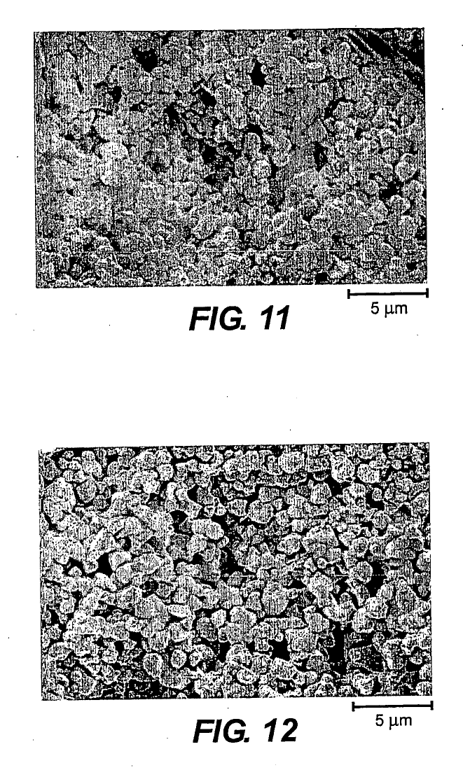

The HIPE was coated at 100 μm thickness onto aluminium foil, laminated with a piece of flat polyester and cured in the oven at 70° C. for a minimum of 6 hours. The polyester laminate was removed and the coating allowed to dry at 60° C. for a minimum of 2 hours. The resultant coating was examined by Scanning Electron Microscopy (FIG. 11) and showed a slightly different polymer structure but the coating was still very highly absorbent.

### Example 12

A polyHIPE coating was prepared using a redox couple initiator system as follows. A solution of ammonium persulfate (0.1 g) and calcium chloride (1 g) in water (45 ml) was sparged with Nitrogen gas for 20 minutes. Another solution of sodium metabisulfite (0.08 g) in water (45 ml) was also sparged with nitrogen for 20 minutes. The two solutions were mixed and addition to the monomer and surfactant mixture immediately started following the method of Example 1. Three coatings were made on a latex-coated polyester base and laminated with clean polyester sheet then cured at different temperatures overnight: 25° C., 40° C. and 50° C. followed by drying at 60° C. after removing the polyester laminate sheet.

All three coatings were highly absorbent, the 50° C. cured sample absorbing the drop in some 40 ms, although the sample cured at 25° C. was less porous as evidenced by SEM.

### Example 13

A polyHIPE coating was prepared using initiator in both aqueous and organic phases as follows. The organic phase was made up as for Example 11 and the aqueous phase as for Example 1. Following the process described in Example 1, the coating was found to be less porous with less well-defined structure but still highly absorbent.

### Example 14

A polyHIPE coating was prepared using a redox couple initiator in the aqueous phase and AIBN in the organic phase as follows. The organic phase was prepared as in Example 11 and the aqueous phase as in Example 12. The resultant polyHIPE coating on aluminium foil was highly porous and absorbent.

### Example 15

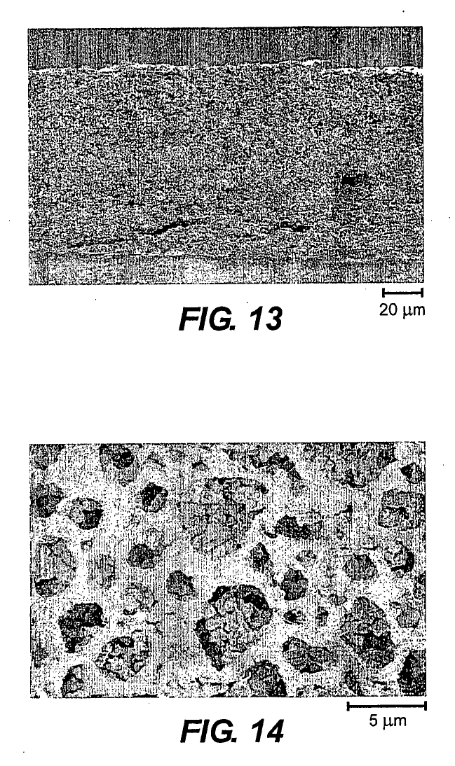

A polyHIPE coating was prepared in which the HIPE was coated onto the support by extrusion coating. The HIPE was prepared according to Example 1 and a syringe pump and hopper was used to extrude a thin layer onto latex-coated polyester. The coated layer was then laminated with untreated polyester and cured at 70° C. for 12 hours and then the laminate removed and the sample dried at 60° C. for a minimum of 2 hours. The coating had good porosity and absorbency. FIG. 12 shows a top view SEM of such a coating at 5000× magnification and FIG. 13 shows the same coating as a cross-sectional SEM at 625× magnification. The effect of reducing the rate of extrusion (to 7 ml/min) can be seen in FIG. 14, which is a top view SEM at 5000× magnification and shows a coating that has a mixture of structures.

### Example 16

A practical assessment of the porosity of the poly(HIPE) materials was made in the following way. A substantial volume of the poly(HIPE) was fully immersed in water for 5 minutes. It was then carefully removed, weighed immediately and placed in a desiccator. The sample was reweighed periodically until a consistent reading was obtained which indicated the complete removal of water from the pore system. The porosity of the sample was calculated from these data together with a knowledge of the density of water and the component materials as:

$$Porosity ( \% ) = \frac{VoidVolume}{TotalVolume} \times 100$$

That is, in this case:

$$Porosity ( \% ) = \frac{WetVolume - DryVolume}{WetVolume} \times 100$$

TABLE 2
Measured porosity of various polyHIPE coatings

| Example No. | Porosity |
|---|---|
| 1 | 84.5 |
| 2 (4000 rpm) | 84.9 |
| 2 (6000 rpm) | 84.2 |
| 3 | 90.0 |

As can be seen from Table 2, the ink-receiving layers formed according to Example 2, at 4000 and 6000 rpm, which had substantially reduced pore dimensions as compared with the ink-receiving layer formed according to Example 1, have approximately the same degree of porosity as that formed according to Example 1. The shear rate of mixing the emulsion therefore affects the pore size, without a significant effect on the overall porosity of the ink-receiving layer formed. The ink-receiving layer formed in Example 3, however, in which a porogen was added to the oil phase of the emulsion, had a substantially greater degree of porosity as compared with that prepared according to Example 1.

1. An inkjet receiver having a liquid-receiving layer made by a process comprising:
generating an emulsion comprising a first phase having a first carrier fluid and a second phase having a second carrier fluid, said first and second carrier fluids being immiscible;
coating said emulsion onto a support;
carrying out a first treatment to at least one component of said first phase to form and/or maintain a skeletal structure of the said treated at least one component of said first phase; and
carrying out a second treatment to substantially remove said carrier fluid thereby generating a large capacity porous structure defined by said skeletal structure for rapid uptake of ink.

2-4. (canceled)

5. The inkjet receiver of claim 1 wherein said emulsion is a biphasic emulsion comprising an oil phase as said first phase and an aqueous phase as said second phase.

6. The inkjet receiver of claim 1, wherein said emulsion is a high internal phase emulsion.

7. (canceled)

8. The inkjet receiver of claim 1, wherein one component of said first phase is a polymerisable monomer and said first treatment is a polymerisation step for polymerising said polymerisable monomer thereby forming said skeletal polymer structure.

9-10. (canceled)

11. The inkjet receiver of claim 8, wherein said polymerisation step is initiated by heating at least one initiator precursor being comprised in said aqueous first phase and/or at least one initiator precursor being comprised in said oil second phase.

12. (canceled)

13. The inkjet receiver of claim 11, wherein said polymerisation step is initiated by heating at least one initiator precursor in said aqueous phase and wherein said initiator precursor is potassium persulfate.

14. The inkjet receiver of claim 8, wherein said at least one polymerisable monomer comprises one or more of styrene, α-methylstyrene, chloro-methylstyrene, vinylethylbenzene, vinyl toluene, 2-ethylhexyl acrylate, n-butyl acrylate, isobutyl acrylate, t-butyl acrylate, hexyl acrylate, n-butyl methacrylate, lauryl methacrylate, isodecyl methacrylate butadiene, isoprene, piperylene, allene, methyl allene, chloroallene, vinyl chloride, vinyl fluoride and polyfluoro-olefins.

15. (canceled)

16. The inkjet receiver of claim 5, wherein said oil phase further comprises at least one cross-linker monomer.

17. The inkjet receiver of claim 16, wherein said cross-linker monomer is divinyl benzene.

18. (canceled)

19. The inkjet receiver of claim 5, wherein said emulsion further comprises in said oil phase a high internal phase emulsion stabilising surfactant comprising one or more of sorbitan monooleate and glycerol monooleate.

20. The inkjet receiver of claim 1, wherein said first phase further comprises a porogen.

21. (canceled)

22. The inkjet receiver of claim 5, wherein said aqueous phase further comprises a water-soluble swellable polymer.

23. The inkjet receiver of claim 22, wherein said water-soluble swellable polymer is polyvinyl alcohol.

24. (canceled)

25. The inkjet receiver of claim 5, wherein said emulsion is generated by mixing said oil phase and said aqueous phase in a mixer at a shear rate of greater than 2000 rpm.

26. The inkjet receiver of claim 1, wherein said skeletal structure comprises pores of an average pore size of 0.1 μm or less.

27. (canceled)

28. The inkjet receiver of claim 1, wherein said skeletal structure comprises a porous cross-linked polymeric material.

29-39. (canceled)

40. A process for the preparation of an inkjet receiver having a liquid-receiving layer, said process comprising:
generating an emulsion comprising a first phase having a first carrier fluid and a second phase having a second carrier fluid, said first and second carrier fluids being immiscible;
coating said emulsion onto a support;
carrying out a first treatment to at least one component of said first phase to form and/or maintain a skeletal structure of said treated at least one component of said first phase; and
carrying out a second treatment to substantially remove said carrier fluid thereby generating a large capacity porous structure defined by said skeletal structure for rapid uptake of ink.
